(19) United States
(12) Patent Application Publication
(10) Pub. No.: US 2026/0087952 A1
(43) Pub. Date: Mar. 26, 2026

(54) SYNCHRONIZATION IN A MULTI-CONTROLLER SYSTEM

(71) Applicant: TEXAS INSTRUMENTS INCORPORATED, Dallas, TX (US)

(72) Inventors: Rohit Goel, Bangalore-Bagmane (IN); Dale Brookner, Allen, TX (US); Alsaad Lambe, Mumbra, Thane (IN)

(21) Appl. No.: 19/338,110

(22) Filed: Sep. 24, 2025

Related U.S. Application Data
(60) Provisional application No. 63/699,366, filed on Sep. 26, 2024.

(51) Int. Cl. G09G 3/00; G06F 9/48; G06F 9/52

(52) U.S. Cl. CPC G09G 3/001; G06F 9/4812; G06F 9/52

(57) ABSTRACT

Techniques for synchronizing operation among multiple controllers. In an example, a method includes generating, at a first controller, a first synchronization word for a task, the first synchronization word including a first controller identification (ID) that identifies the first controller, and outputting, by the first controller, an output data signal including the first synchronization word. The method further includes receiving, at the first controller, an input data signal that includes a second synchronization word for the task, the second synchronization word including a second controller ID that identifies a second controller, updating, by the first controller and responsive to receiving the second synchronization word, an interrupt status record for the task, and generating, responsive to the interrupt status record reaching a threshold value, an interrupt signal instructing the first controller to perform the task, and outputting, by the first controller, the output data signal including the second synchronization word.

### CROSS-REFERENCE TO RELATED APPLICATION

This application claims priority to co-pending U.S. Provisional Application No. 63/699,366 titled “REAL-TIME SOFTWARE SYNCHRONIZATION METHOD IN A MULTI-CONTROLLER SYSTEM” and filed on Sep. 26, 2024, which is hereby incorporated herein by reference in its entirety.

### TECHNICAL FIELD

This description relates to control systems and, more particularly, to techniques for synchronization among multiple controllers.

### BACKGROUND

In some systems, such as some display systems, multiple controllers (e.g., multiple processors) share control of a device, such as a display device. Accordingly, the controllers may need to be synchronized with one another such that each performs tasks at appropriate times relative to the timing of tasks performed by the other controllers. In systems where the controllers do not have access to shared memory, standard peripheral interface protocols, such as I2C, SPI, etc., can be used to communicate the data needed for synchronization. However, the use of such interfaces may have drawbacks, such as data overhead, low data rate, and/or may introduce a need for data arbitration handling processes, which may increase complexity.

### SUMMARY

In one example, a method comprises generating, at a first controller, a first synchronization word for a task, the first synchronization word including a first controller identification (ID) that identifies the first controller; outputting, by the first controller, an output data signal including the first synchronization word; receiving, at the first controller, an input data signal that includes a second synchronization word for the task, the second synchronization word including a second controller ID that identifies a second controller; updating, with synchronization circuitry of the first controller and responsive to receiving the second synchronization word, an interrupt status record for the task; generating, with the synchronization circuitry and responsive to the interrupt status record reaching a threshold value, an interrupt signal instructing the first controller to perform the task; and outputting, by the first controller, the output data signal including the second synchronization word.

In another example, a controller comprises a processor configured to generate a first synchronization word including a task identification (ID) and a first controller ID, and synchronization circuitry coupled to the processor. In an example, the synchronization circuitry includes input circuitry having a data input port to receive an input data signal, and a clock input port to receive an input clock signal, the input data signal including a second synchronization word that includes the task ID and a second controller ID, and synchronization interface circuitry coupled to the processor and to the input circuitry, the synchronization interface circuitry configured to store the first and second synchronization words and an interrupt status record for the task ID. The synchronization circuitry may further include output circuitry coupled to the input circuitry and to the processor, the output circuitry having a data output port and a clock output port, the output circuitry configured to provide, at the data output port, an output data signal including the first synchronization word and the second synchronization word, and to provide, at the clock output port, an output clock signal. The synchronization circuitry may be configured to update the interrupt status record for the task ID responsive to receiving the second synchronization word, and to generate an interrupt to the processor responsive to the interrupt status record reaching a threshold value, the threshold value being based on an expected number of controller IDs.

In another example, a system comprises a plurality of controllers each having a data input terminal, a data output terminal, a clock input terminal, and a clock output terminal, the plurality of controllers connected to one another in a ring configuration. Each controller may comprise a processor configured to generate a synchronization word that identifies the controller and a task, and synchronization circuitry coupled to the data input terminal, the data output terminal, the clock input terminal, the clock output terminal, and the processor. The synchronization circuitry can be configured to update an interrupt status record for the task responsive to receiving, via the data input terminal, an input data signal including one or more synchronization words from at least one of the plurality of controllers, the one or more synchronization words identifying the task, generate an interrupt to the processor responsive to the interrupt status record for the task reaching a threshold value, the interrupt instructing the processor to perform the task, and the threshold value corresponding to a number of controllers in the plurality of controllers, and provide, at the data output terminal, an output data signal that includes the synchronization word generated by the processor and the one or more synchronization words received included in the input data signal.

### BRIEF DESCRIPTION OF THE DRAWINGS

FIG. 1 is a block diagram of a light projection system, according to an example.

FIG. 2 is a block diagram showing a plurality of controllers coupled together in a ring configuration, according to an example.

FIG. 3 is a graph showing clock and data waveforms, according to an example.

FIG. 4 is a diagram illustrating a synchronization word, according to an example.

FIG. 5 is a block diagram of a multi-controller synchronization circuit, according to an example.

FIG. 6 is a flow diagram of a method of synchronizing multiple controllers, according to an example.

### DETAILED DESCRIPTION

Techniques are described for synchronizing operation among multiple controllers. The techniques can be used in any number of scenarios, but are particularly useful for synchronizing operation among multiple controllers that lack access to shared memory. As described further below, some examples provide synchronization circuitry that can be implemented as a sub-block of a controller and can perform real-time synchronization among multiple controllers that include the circuitry. In some examples, controller firmware can be programmed with task-specific synchronization codes, and a hardware-based portion of the synchronization circuitry can handle transfer of the synchronization codes among multiple controllers. These synchronization codes can be used to synchronize execution of the controller firmware at various points in the operation of the controllers.

Accordingly, in one example, a method comprises generating, at a first controller, a first synchronization word for a task, the first synchronization word including a first controller identification (ID) that identifies the first controller, and outputting, by the first controller, an output data signal including the first synchronization word. The method may further comprise receiving, at the first controller, an input data signal that includes a second synchronization word for the task, the second synchronization word including a second controller ID that identifies a second controller. The example method further includes updating, with synchronization circuitry of the first controller and responsive to receiving the second synchronization word, an interrupt status record for the task. The example method further includes generating, with the synchronization circuitry and responsive to the interrupt status record reaching a threshold value, an interrupt signal instructing the first controller to perform the task, and outputting, by the first controller, the output data signal including the second synchronization word.

### General Overview

In various systems and applications, multiple controllers (e.g., multiple processors and associated circuitry) work together to control the operation of other devices. For instance, in a digital light projection system, a controller formats the input video data and loads it into a display device, such as a spatial light modulator (SLM). The controller controls both the SLM and an illumination system that illuminates the SLM, in real time, to generate the image on a screen or other display surface. In some such cases, the controller runs a real-time operating system and control software with multiple tasks that perform various functionalities, such as SLM and illumination control, power management, image processing, and source switching, to name a few examples. These tasks switch at high frequency and run in coordination with each other to produce artifact-free images on the display surface. In some instances, a single controller may be capable of driving an SLM of certain resolution to produce an image with a particular resolution. However, in some cases, to produce higher resolution images, multiple controllers can be used together to drive a larger SLM of higher resolution. To generate the higher resolution image that is free, or substantially free, of artifacts, numerous tasks performed by an individual controller, such as any of the tasks identified above, may need to be synchronized with corresponding tasks performed by the other controllers. Furthermore, in display systems or other systems operating in real-time, it may be preferable to synchronize tasks across multiple controllers with minimal latency. If time-sensitive tasks are not properly synchronized with one another, various issues may arise. For example, multiple tasks switching at high frequency on the individual controllers may lead to unintended synchronized performance of a task by one controller with a different task by another controller, which may cause image artifacts or even system failures. In some implementations, such as those in which the multiple controllers are multiple cores of a single processor, the multiple controllers may have access to shared memory registers that can be used for synchronization. However, in implementations in which the multiple controllers (e.g., implemented using multiple different processors) lack access to shared memory, other synchronization techniques are needed. Protocols for peripheral communication, such as I2C or SPI, can be used; however, these approaches may have limitations, such as data overhead, low data rate, and/or lack of data arbitration processes, that may make them inefficient to use for synchronization.

To address these and other issues, examples described herein provide techniques for synchronization among multiple controllers. In certain examples, the techniques may be implemented using synchronization codes (e.g., synchronization words that can be serialized into a signal) that can be transferred between the controllers. The synchronization codes may identify specific tasks and can be used to synchronize execution of the controller firmware corresponding to those tasks. According to certain examples, individual tasks to be synchronized among multiple controllers in a coordinated group of controllers are assigned a task identifier, and each controller in the group is assigned a controller identifier. Synchronization codes generated by individual controllers may include both the task identifier and the controller identifier. According to certain examples, firmware executing on the individual controllers causes transmission of the synchronization codes at certain points during execution of the corresponding tasks, and the individual controllers may then wait to receive the corresponding synchronization codes from the other controllers in the group. Once a controller has received the synchronization codes for a particular task from all the controllers in the group, the controller may proceed with executing the task. In this manner, execution of the task can be synchronized at the multiple controllers, and without the use of any shared memory.

Accordingly, in some examples, a method that can be performed by a controller includes generating, at the controller, a first synchronization word for a task, the first synchronization word including a first controller identification (ID) that identifies the controller, and outputting, by the first controller, an output data signal including the first synchronization word. The method may further include receiving, at the controller, an input data signal that includes a second synchronization word for the task, the second synchronization word including a second controller ID that identifies another controller. In some examples, the method further includes receiving, at the first controller, the input data signal including the first synchronization word that has been relayed via one or more other controllers (e.g., the second controller) back to the first controller. The method may further include updating, with synchronization circuitry of the controller and responsive to receiving the second synchronization word, an interrupt status record for the task. Similarly, the interrupt status record can be updated responsive to receiving the relayed first synchronization word. In this manner, the controller may keep track as it receives synchronizations words for the task from other controllers, as well as its own synchronization task relayed back to itself. In some examples, the method further includes generating, with the synchronization circuitry and responsive to the interrupt status record reaching a threshold value, an interrupt signal instructing the controller to perform the task. In some examples, the threshold value corresponds to, or is based on, the number of controllers in the group. The method may further include outputting, by the controller, the output data signal including the second synchronization word. Thus, the controller may relay the synchronization words to other controllers. The above-described actions need not be performed in a particular order, except where noted that an action depends on (or is performed responsive to) another action. For example, the first controller may output the output data signal including the second synchronization word before or after it receives the input data signal including the first synchronization word that has been relayed back to the first controller. Similarly, depending on when the threshold value of the interrupt status record is reached, the first controller may output the output data signal including the second synchronization word before or after is generates the interrupt signal. Numerous variations are possible.

Further examples are directed to controllers, and systems including controllers, that may perform the method and variations thereof. These and other aspects are described in more detail below.

### Example System Architecture

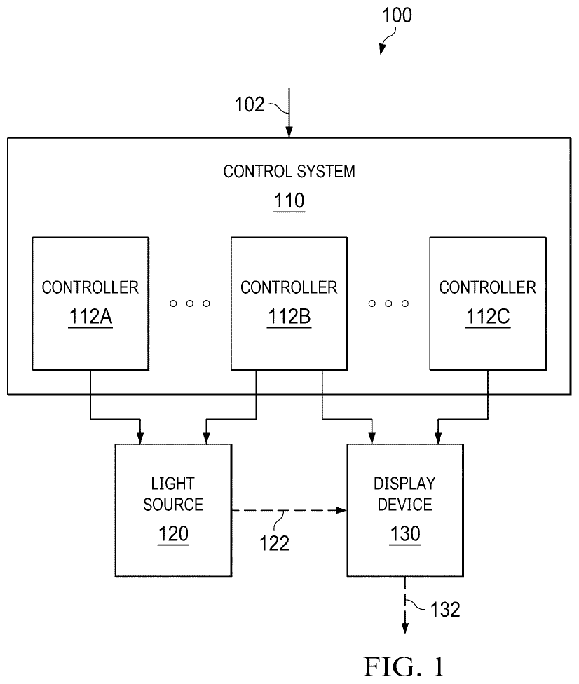

FIG. 1A is a block diagram of a light projection system 100 according to an example. In this example, the system 100 includes a control system 110, a light source 120, and a display device 130. Under control of the control system 110, the light source 120 produces an illumination beam (also referred to as illumination light) 122 that illuminates the display device 130. The light source 120 may include elements (not explicitly shown in FIG. 1) such as one or more light emitting devices (e.g., lasers, light emitting diodes, etc.) along with one or more optical elements (e.g., lenses, mirrors, prisms, integrators, homogenizers, etc.) that condition (e.g., focus, collimate, perform optical corrections, etc.) and direct the illumination light 122 to the display device 130. Under control of the control system 110, the display device 130 projects an image 132 responsive to the illumination light 122 and to image data received from the control system 110. In some examples, the display device 130 includes a spatial light modulator (such as a digital mirror device, liquid crystal display device, or liquid crystal on silicon device, for example) that modulates the illumination light 122 to produce the image 132.

According to certain examples, the control system 110 receives image data 102 from an external source, the image data describing the image 132 to be projected by the display device 130. Responsive to the image data 102, the control system 110 controls the light source 120 and the display device 130 to produce the image 132. In some examples, the control system 110 may include a plurality of controllers 112 (individually identified as controllers 112A, 112B, and 112C in FIG. 1) that operate in coordination with one another to control operation of the light source 120 and the display device 130 to project the image 132. Individual controllers 112A, 112B, 112C may control operation of the light source 120 and/or the display device 130. In addition to controlling the light source 120 and/or the display device 130, any one or more of the controllers 112 may perform additional functions, such as power management, image processing (e.g., processing the image data 102), source switching (e.g., switching between different external sources that supply the image data 102), or other functions that support operation of the system 100. Other examples may be configured, differently. For instance, although three controllers 112 are illustrated in FIG. 1, systems may include more or fewer than three controllers 112 that may operate in concert to control various functionalities of display systems or other systems. For example, a dual-controller light projection system may include the controller 112B (e.g., controlling the light source 120 and the display device 130, optionally in combination with other functions) and the controller 112C (e.g., controlling the display device optionally in combination with other functions). In another example, a quad-controller light projection system may include the controller 112B (e.g., controlling the light source 120 and the display device 130, optionally in combination with other functions) along with three controllers 112C (e.g., controlling the display device 130 optionally in combination with other functions).

As described above, in a multi-controller system, such as the system 100, for example, techniques can be employed to synchronize the controllers 112 such that the individual controllers 112A, 112B, 112C execute tasks, particularly time-sensitive tasks, at appropriate times relative to one another. Synchronization among the controllers 112A, 112B, 112C may allow the system 100 to generate high-resolution images 132 that are substantially free of artifacts. Accordingly, in some examples, the individual controllers 112A, 112B, 112C can be provided with synchronization circuitry that can be configured to allow for the exchange of synchronization codes among the controllers 112, as described above.

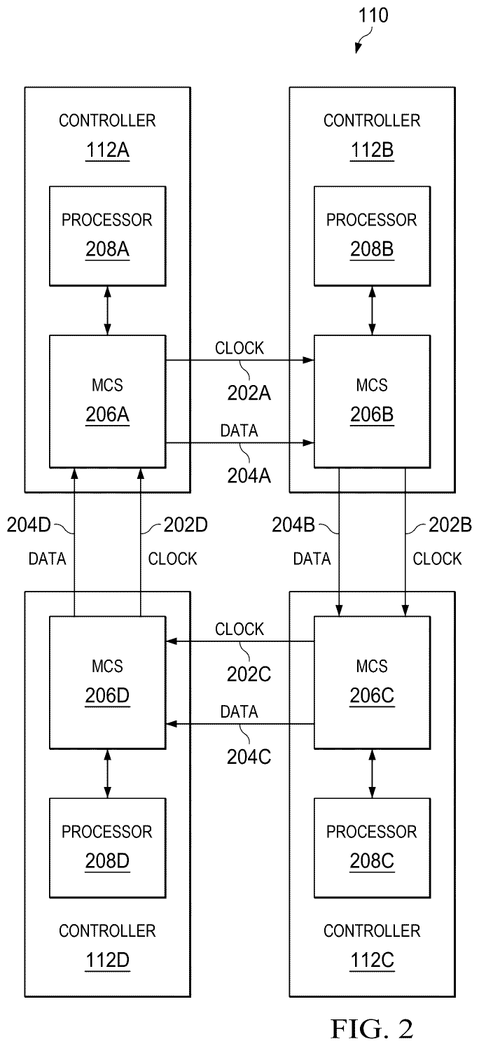

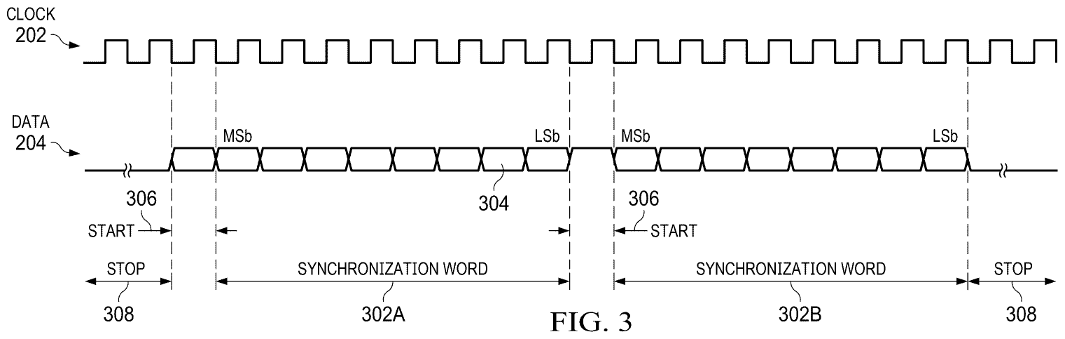

FIG. 2 is a block diagram illustrating an arrangement of multiple controllers 112 according to an example. In the illustrated example, the control system 110 includes a group of four controllers 112 (individually identified as controllers 112A, 112B, 112C, 112D) that are mutually coupled together. The controllers 112 transmit clock signals 202 (individually identified as clock signals 202A-D) and data signals 204 (individually identified as data signals 204A-D) among one another. In some examples, the clock signals 202A-D all have the same clock frequency, but are not necessarily synchronized with one another. FIG. 3 illustrates an example of a clock signal 202. The clock signals 202A-D provide timing for reading of the data signals 204A-D, as described further below. According to certain examples, the individual controllers 112A-D include a respective multi-controller synchronization (MCS) circuit 206 (individually identified as MCS circuits 206A, 206B, 206C, 206D), as shown. The MCS circuits 206 (also referred to as synchronization circuits or synchronization circuitry) handle transfer of the clock signals 202 and data signals 204 among the controllers 112. The individual controllers 112A-D may further include a respective processor 208 (individually identified as processors 208A, 208B, 208C, and 208D) coupled to the respective MCS circuits 206, as illustrated. The processors 208 may control or effect operation of individual controllers 112 to perform any of the functionality described above.

The data signals 204 include synchronization codes that facilitate synchronizing the execution of particular tasks among the controllers 112A-D. In some examples, the synchronization codes, which may also be referred to as synchronization words, are multi-bit codes that are programmed into the firmware of the individual controllers 112A-D and used to synchronize execution of the firmware at particular points. Individual tasks that are to be synchronized among the controllers 112A-D may be assigned individual task identifiers that form part of the synchronization codes. According to certain examples, each controller 112 transmits a particular synchronization code at a particular point during execution of the controller firmware, and then waits to proceed with the corresponding task until it has received the same synchronization code from each of the other controllers 112. In some examples, the MCS circuits 206 have an external interface that uses a ring architecture, in which the synchronization codes are transmitted from an originating controller 112 and then serially transferred through the other controllers 112 until being received back at the originating controller. Thus, as illustrated in FIG. 2, the controllers 112A-D can be connected together in a ring configuration. As used herein, the term ring configuration is intended to describe a network topology in which the controllers 112 are coupled, via communication paths, in a closed loop, with each controller coupled to at least one other controller. The communication path among the controllers 112 can be considered to begin and end at any one of the controllers 112. Phrased another way, data transmitted by one controller may be serially relayed among the other controllers connected in the ring configuration, from controller to controller, until the data is returned to the original transmitting controller. The ring configuration refers to the communication path between the MCS circuits 206 of the controllers 112 and is not intended to imply any particular physical arrangement of the controllers with respect to one another.

In the example of FIG. 2, the first controller 112A transmits a first clock signal 202A and a first data signal 204A to the second controller 112B. The second controller 112B transmits a second clock signal 202B and a second data signal 204B to the third controller 112C. The third controller 112C transmits a third clock signal 202C and a third data signal 204C to the fourth controller 112D, and the fourth controller 112D transmits a fourth clock signal 202D and a fourth data signal 204D to the first controller 112A. Thus, as described above, the controllers 112A, 112B, 112C, 112D are coupled together in a ring configuration in which the clock signals 202 and data signals 204 are transferred from one controller to another. However, as described above, in other examples, more or fewer than four controllers 112 can be connected in the ring architecture.

FIG. 3 illustrates an example of a clock signal 202 and a data signal 204 that may represent a portion of any of the clock signals 202A-D and the data signals 204A-D, respectively. In some examples, the clock signal 202 has a frequency of 75 megahertz (MHz); however, in other examples, other clock frequencies can be used. The data signal 204 includes a plurality of synchronization words (or codes) 302, with a first synchronization word 302A and a second synchronization word 302B being illustrated in FIG. 3. Each synchronization word 302 includes a plurality of bits 304, arranged from a most significant bit (Msb) to a least significant bit (Lsb). In some examples, there is a nine bit per cycle (9-bit/cycle) protocol associated with the transfer of each synchronization word 302. However, in other examples, a different number of bits per cycle can be used. In the illustrated example, each bit transition in the data signal 204 occurs on the negative edge of the clock signal 202, and is sampled by the receiving controller 112 on the positive edge of the clock signal 202. However, in other examples, the opposite arrangement may be implemented.

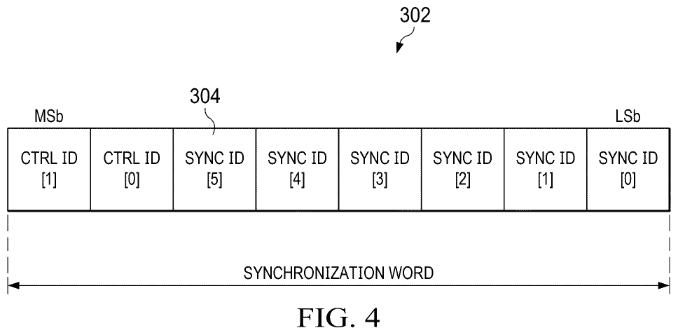

In some examples, an N-bit per cycle sequence begins with at least one “Start” bit, followed by an M-bit synchronization word 302. Thus, in the illustrated example, the 9-bit/cycle sequence begins with a Start bit 306 (always DATA=‘1’), followed by the 8-bit synchronization word 302. In the illustrated example, the Start bit 306 is represented by a logical 1 in the data signal 204; however, in other examples, a logical 0 can be used. Further, in the illustrated example, the synchronization word 302s are transmitted from MSb to LSb; however, in other examples, the synchronization words can be transmitted from Lsb to Msb. In some examples, the first two (MSb and one other) bits 304 of the synchronization word 302 represent an identifier of the transmitted controller (referred to herein as a Controller ID or CTRL_ID[1:0]). In such examples, the remaining six (five plus Lsb) bits 304 of the synchronization word 302 represent a 6-bit task identifier (referred to herein as a Task ID, TASK_ID, or SYNC_ID). A synchronization word 302 having this format is illustrated in FIG. 4.

According to certain examples, each individual controller 112A-D in the group is assigned a unique Controller ID. In some examples, software executing on the respective controller 112 can derive the Controller ID from a controller value that is sampled on set-up pins of the controller at power-up of the controller. In other examples, the software may derive the Controller ID from design specifications of the respective controller 112. In other examples, the Controller ID may be programmed or encoded into the software or firmware of the controller 112. Similarly, each task to be synchronized among the controllers 112A-D may be assigned a unique Task ID. In some examples, it may be desirable to synchronize execution of a particular task at more than one point during the task. In such cases, individual synchronization points within the particular task can be assigned unique task IDs. The Task IDs can be programmed or encoded into the software or firmware of the controllers 112s. The 8-bit synchronization word 302 example illustrated in FIG. 4 allows for up to four unique Controller IDs (and therefore, four controllers 112) and 64 unique Task IDs (and therefore, 64 tasks or task synchronization points). However, in other examples, the total number of bits 304 of the synchronization words 302, the number of bits 304 used to represent the Controller IDs, and/or the number of bits 304 used to represent the Task IDs can be altered depending on the number of controllers 112 in a group and/or the number of tasks or synchronization points within tasks to be accommodated. Furthermore, although in the example of FIG. 4, the two most significant bits 304 of the synchronization word 302 are used for the Controller ID, in other examples, the two (or some other number) least significant bits 304 can be used for the Controller ID and the remaining more significant bits used for the Task ID.

Referring again to FIG. 3, the clock signal 202 may be free-running whenever the multi-controller synchronization (MCS) function is enabled, and may remain static when the MCS function is disabled. This behavior may simplify internal clock domain crossing design implementation details for the MCS circuitry 206. In some examples, the clock signal 202 may remain static at the logical 0 level when the MCS function is disabled; however, in other examples, the clock signal 202 may remain static at the logical 1 level when the MCS function is disabled. According to certain examples, the data signal 204 remains static (e.g., in a Stop condition/cycle 308) when the MCS circuit 206 is idle between synchronization word transfers. In examples in which logical 1 is used for the Start bit(s) 306, the data signal 204 may remain static at the logical 0 level during the Stop cycles 308. However, in other examples, the data signal 204 may remain static at the logical 1 level during the Stop cycles 308. In some examples, Stop cycles 308 are not required between consecutive synchronization word transfers (e.g., transfer cycles for the two synchronization words 302A, 302B can abut, as shown in FIG. 3).

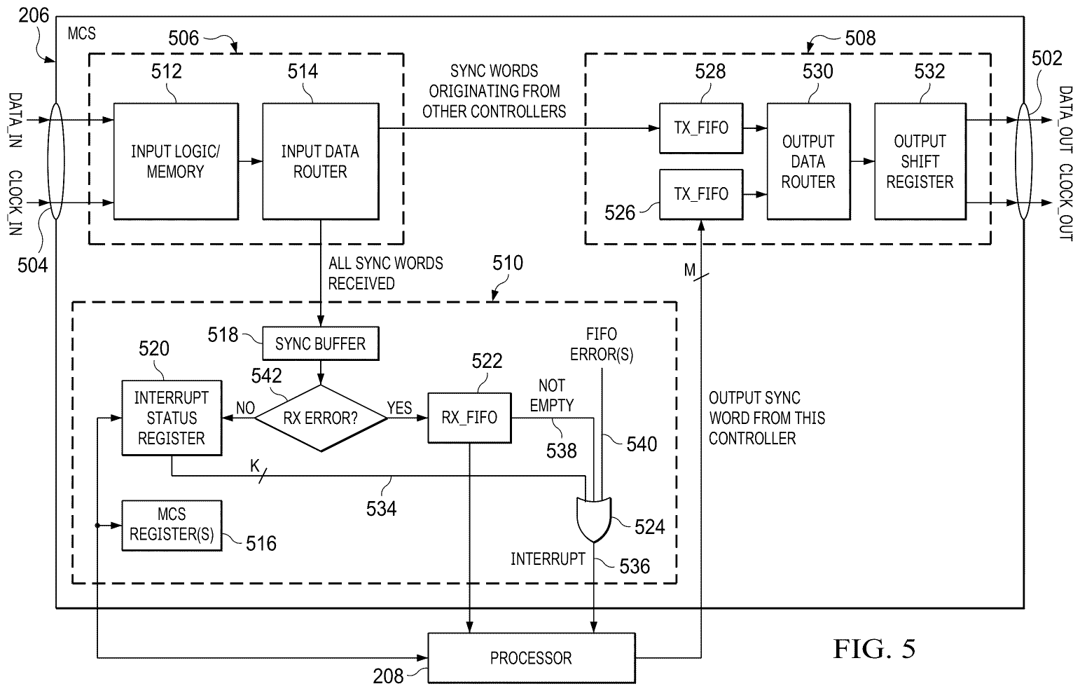

Turning to FIG. 5, an example of the MCS circuit 206 is illustrated. As described above, in some examples, a source-synchronous, two-signal (e.g., the clock signal 202 and the data signal 204) interface is provided between the controllers 112. Accordingly, the MCS circuit 206 has an output port 502 transmitting an outgoing clock signal 202 (CLOCK_OUT) and an outgoing data signal 204 (DATA_OUT) containing one or more synchronization words 302, and an input port 504 for receiving an incoming clock signal 202 (CLOCK_IN) and an incoming data signal 204 (DATA_IN) containing one or more synchronization words 302. The input port 504 may include an input data port or terminal for receiving the input data signal and an input clock port or terminal for receiving the incoming clock signal. Similarly, the output port 502 may include an output data port or terminal for transmitting the outgoing data signal and an output clock port or terminal for transmitting the outgoing clock signal. In some examples, the MCS circuit 206 includes input circuitry 506 (that is coupled to or includes the input port 504), output circuitry 508 (that is coupled to or includes the output port 502), and processing circuitry 510. In some examples, the input circuitry 506, the output circuitry 508, and the processing circuitry 510 each comprise digital logic circuitry and/or memory and operate in respective asynchronous clock domains. As described above, in some examples, the incoming and outgoing clock signals 202 (CLOCK_IN and CLOCK_OUT) have clock frequencies of 75 MHz, although other frequencies can be used. In some examples, the processing circuitry 510 operates on a clock frequency (e.g., for reading and/or writing various registers) that is higher than the clock frequency of the clock signals 202, thereby allowing the processing circuitry 510 to process information derived from the incoming data signal 204 more quickly. For example, the processing circuitry 510 may operate based on a clock signal of 150 MHz, although other clock frequencies can be used.

According to certain examples, the input circuitry 506 is coupled to the processing circuitry 510 and is configured to transfer received synchronization words 302 to the processing circuitry 510 and to the output circuitry 508, as described further below. Accordingly, the input circuitry 506 may include input logic/memory circuitry 512 and an input data router 514 coupled to the input logic/memory circuitry 512. The input data router 514 may also be implemented using digital logic and/or memory. Operation of the input circuitry 506 is described below. The processing circuitry 510 is coupled to the processor 208, which is also coupled to the output circuitry 508. In some examples, software executing on the processor 208 uses a software-writable transmit first-in first-out (TX_FIFO) interface (implemented at least in part in the output circuitry 508) for sending synchronization codes 302 to other controllers, and an interrupt status register interface (implemented at least in part in the processing circuitry 510) for monitoring incoming synchronization codes 302 received from other controllers 112, as described further below.

The processing circuitry 510 may include digital logic and/or memory devices that provide a software-accessible interface to the processor 208. In particular, the processing circuitry 510 may include one or more memory-mapped MCS registers 516 that are accessible to software executing on the processor 208. The processing circuitry 510 may be coupled to the processor 208 via one or more peripheral ports (not explicitly illustrated) of the processor 208. In some examples, the processing circuitry 510 includes a synchronization buffer 518 coupled to the input data router 514 and configured to receive synchronization codes 302 from the input circuitry 506. The processing circuitry 510 may further include an interrupt status register 520 and a receive buffer 522 (which may also be referred to as an error buffer). The receive buffer 522 may be a first-in, first-out (FIFO) receive buffer (RX_FIFO). The receive buffer 522 may be implemented using two-port (e.g., read and write( random access memory (RAM), for example. The interrupt status register 520 and the one or more MCS registers 516 are accessible to the processor 208 for read and/or write operations, and the receive buffer 522 may be accessible to the processor 208 for read operations, as described further below. The processing circuitry 510 may further include interrupt circuitry 524 coupled to the interrupt status register 520, to the receive buffer 522, and to the processor 208. The interrupt circuitry may produce an interrupt signal 536 that may be provided to the processor 208 to trigger the processor 208 to perform a particular task or take some other action, as described further below. The interrupt circuitry 524 is illustrated symbolically as an OR gate in FIG. 5 to represent that the interrupt signal 536 can be produced in response to any one or more conditions, as described below; however, the interrupt circuity may be implemented using various digital logic and/or memory devices.

The processing circuitry 510 may be configurable to report the transfer status of synchronization codes 302 and to report any detected error conditions. Through the register interfaces provided via the processing circuitry 510 and the output circuitry 508, the processor 208 (e.g., through software executing on the processor 208) can initiate the transfer of a synchronization code 302 to another controller 112 by writing the synchronization code 302 to a first transmit buffer 526 of the output circuitry 508. The output circuitry 508 may then assemble the synchronization code 302 into the data signal 204 (DATA_OUT) for transmission to another controller 112. Via the processing circuitry 510, the processor 208 may further verify successful reception of synchronization codes 302 from the other controllers 112 by monitoring bits of the interrupt status register 520. In some examples, the register bits of the interrupt status register 520 have corresponding interrupt enable bits (e.g., stored in an interrupt enable register that is included in the one or more MCS registers 516) to allow for either interrupt-driven or software polling modes of operation, as described below. Furthermore, the processor 208 may retrieve synchronization codes 302 received in error (e.g., for debug purposes) by reading them from the receive buffer 522, as described further below.

Continuing with the example of FIG. 5, the output circuitry 508 may include digital logic circuitry and/or memory configurable for transmitting or relaying synchronization codes 302 to the next controller 112 in the ring configuration via the output port 502. In some examples, the output circuitry 508 includes the first transmit buffer 526 and a second transmit buffer 528. The two transmit buffers 526, 528 may be FIFO buffers (TX_FIFO). In some examples, the first transmit buffer 526 is writable by software executing on the processor 208, and may be used for transmitting the synchronization codes 302 that are generated at the controller 112 hosting the particular MCS circuit 206. The second transmit buffer 528 may be writeable by the input circuitry 506 (e.g., via the input data router 514) and may be used for relaying synchronization codes 302 received from a preceding controller 112 in the ring configuration to the next controller 112 in the ring configuration. The first and second transmit buffers 526, 528, respectively, may be implemented using two-port (e.g., read and write) random access memory (RAM), for example. The output circuitry may further include an output data router 530 and an output shift register 532 coupled to the output port 502. The output data router 530 (which may be implemented using digital logic circuitry, for example) may read synchronization codes 302 from both the first and second transmit buffers 526, 528, respectively. In some examples, the output data router 530 uses a round-robin arbitration scheme to select which transmit buffer to read next whenever both the first and second transmit buffers 526, 528, respectively, contain synchronization words for transmission. The output data router 530, in combination with the output shift register 532 serializes the data (e.g., the synchronization code(s) 302 read from the first and/or second transmit buffers 526, 528, respectively, along with appropriate Start bits 306) to construct the data signal 204 (DATA_OUT) to be sent out to the next controller 112 via the output port 502. The outgoing data signal 204 can be clocked into and out of the output shift register 532 according to the outgoing clock signal 202 (CLOCK_OUT).

As described above, when the MCS function of a controller 112 is enabled, the outgoing clock signal 202 may be free-running. Accordingly, in some examples, the one or more MCS registers 516 include an MCS function enable (FEN) register, or register bit(s), that can be used to control operation of the outgoing clock signal 202. For example, the outgoing clock signal 202 can be held static at the logical 0 level when the MCS function is disabled and be free-running (e.g., toggling between logical 1 (HIGH) and logical 0 (LOW) levels) when the MCS function is enabled In some examples, when the outgoing clock signal 202 is held LOW (e.g., disabled), data may be retained in the first and/or second transmit buffers 526, 528, respectively, rather than being clocked into the output shift register 532 for transmission.

In some examples, the one or more MCS registers 516 may include one or more transmit buffer status registers, or register bits, that record the number of synchronization words stored in the first and second transmit buffers 526, 528, respectively. For example, the transmit buffer status registers may include one or more bits representing a first word count for the first transmit buffer 526 and one or more bits representing a second word count for the second transmit buffer 528. The first word count may specify the number of synchronization words that the processor 208 has written to, and currently reside in, the first transmit buffer 526. In some examples, valid entries for the first word count may range from 0 (i.e., the first transmit buffer 526 is empty) to X (i.e., the first transmit buffer 526 is full), with X being an integer number that may be based on, for example, a number of tasks the controller 112 may be expected to be executing within a certain time period, a size of the first transmit buffer 526, and/or other factors. Similarly, the second word count may specify the number of synchronization words received from other controllers 112 that the input circuitry 506 has written to, and currently reside in, the second transmit buffer 528. Valid entries for the second word count may range from 0 (i.e., the second transmit buffer 528 is empty) to Y (i.e., the second transmit buffer 528 is full), with Y being the same or different than X. In some examples, Y is a higher value than X to accommodate a potentially higher number of synchronization words received from a collection of the other controllers 112.

In some examples, the one or more MCS registers 516 may include a transmit buffer enable registers that include bits specifying whether or not the first transmit buffer 526 is enabled for write operations. For example, an enable bit for the first transmit buffer 526 may be either logical 0 indicating that the first transmit buffer 526 is disabled for writing by software executing on the processor 208 or logical 1 indicating that the first transmit buffer 526 is enabled for writing by software executing on the processor 208, or vice versa. In some examples, if the first word count indicates that the first transmit buffer 526 is full, the enable bit may be set to disable writes to the first transmit buffer 526 until the synchronization words stored therein have been clocked out, freeing up storage space for new synchronization words. In some examples, a write data register (which may be included in the one or more MCS registers 516) may be used to write data from the processor 208 into the first transmit buffer 526. For example, an M-bit Task ID may be written to the write data register, which pushes (writes) the M-bit Task ID to the first transmit buffer 526. In some such examples, the processing circuitry may add the Controller ID (which may be stored in a configuration register included in the one or more MCS registers 516) to produce the synchronization code 302 (including the Task ID and the Controller ID) stored in the first transmit buffer 526. However, in other examples, the processor 208 may write the complete synchronization code to the write data register or to the first transmit buffer 526.

As described above, the input circuitry 506 receives incoming synchronization codes 302 via the incoming data signal 204 (DATA_IN). The input logic/memory circuitry 512 de-serializes the incoming data. In some examples, the input logic/memory circuitry 512 samples the incoming data signal 204 (DATA_IN) on the positive (or negative) edge of the incoming clock signal 202 (CLOCK_IN), as described above, and provides the sampled data to the input data router 514. The input data router 514 transfers synchronization codes 302 that originated from other controllers 112 to the second transmit buffer 528, such that these synchronization codes 302 can be relayed to the next controller 112 in the ring configuration. As described above, each synchronization code 302 may include a Controller ID and a Task ID. Accordingly, the input data router 514 may use the Controller ID to identify those synchronization codes 302 that originated from other controllers 112, and transfer them to the second transmit buffer 528. Based on the Controller ID, synchronization codes originating at other controllers can be differentiated from synchronization codes that originated at the current controller 112 and have “looped back” through the ring configuration. Accordingly, the input data router 514 may direct only the synchronization codes from the other controllers 112 to the second transmit buffer 528. The input data router 514 further directs all incoming synchronization codes 302 to the processing circuitry 510, where corresponding bits of the interrupt status register 520 can be updated accordingly. In particular, in some examples, the received synchronization codes 302 are provided from the input data router 514 to the synchronization buffer 518.

As described above, each synchronization code 302 includes a Task ID that identifies a particular synchronization point in a particular task that is to be executed substantially in synchrony by the processors 208 of the controllers 112 in the ring configuration. As also described above, the controllers 112 may wait to execute a particular task (or portion thereof) until they have received the corresponding Task IDs from all the controllers 112 in the group. Accordingly, for any given Task ID, the processing circuitry 510 may update the interrupt status register 520 to count the number of controllers 112 (e.g., using the Controller IDs to identify individual controllers) from which the synchronization codes for the given Task ID have been received. For example, the interrupt status register 520 may include, for each individual Task ID, a counter that increments whenever a synchronization word with that Task ID includes a new Controller ID. When the counter reaches a certain threshold (e.g., corresponding to the number of controllers in the ring configuration), an interrupt enable signal can be generated, indicating that processor 208 can proceed to execute the corresponding task. In another example, the interrupt status register 520 may include, for any given Task ID, a number of “counting” bits corresponding to the number of controllers in the ring configuration. As the Task ID is received from individual controllers (e.g., as determined via the Controller IDs), the bits for that Task ID can be set (e.g., transitioned from 0 to 1 or vice versa), thus counting the number of controllers 112 that have transmitted the Task ID. When all the counting bits for a given Task ID are set, the interrupt enable signal can be produced. For example, the interrupt status register 520 may further include an interrupt enable bit for the particular Task ID, and the interrupt enable bit can be set (e.g., transitioned from 0 to 1 or vice versa) when all the counting bits for that Task ID have been set. Once the interrupt enable signal is produced, or the interrupt enable bit is set and read out by the processor 208, the counting bits for the Task ID can be reset, such that the processing circuitry 510 can begin to monitor for the next instance of that Task ID.

Referring again to FIG. 2, and with continuing reference to FIG. 5, the following example may demonstrate the monitoring functionality of the processing circuity 510. In an example, the first controller 112A generates a Task ID for synchronization of a particular task referred to as Task-0. The first controller 112A transmits (in the data signal 204A) a first synchronization code 302 to the second controller 112B, the first synchronization code including the Task ID for Task-0 and the Controller ID for the first controller 112A. The second controller 112B receives the data signal 204A, and updates its interrupt status register 520 to note that the Task ID for Task-0 has been received from controller 112A. If controller 112B is also at the appropriate point in execution of its firmware, it may also generate a second synchronization code for Task-0 that includes the Task ID for Task-0 and the Controller ID for the second controller 112B. In this case, the second controller 112B transmits the data signal 204B that includes both the relayed first synchronization code from the first controller 112A (which includes the Task ID for Task-0 and the Controller ID for the first controller 112A) and the second synchronization code from the second controller 112B (which includes the Task ID for Task-0 and the Controller ID for the second controller 112B). Alternatively, if the second controller 112B has not yet reached (in execution of its firmware) the synchronization point associated with Task-0, the data signal 204B transmitted to the third controller 112C will not yet include the second synchronization code from the second controller 112B. Responsive to receiving the second data signal 204, the third controller 112C updates its interrupt status register 520 to reflect receipt of the Task ID for Task-0 from the first controller 112A (relayed via the second controller 112b) and eventually also receipt of the Task ID for Task-0 from the second controller 112B. At the appropriate time, the third controller 112C also generates (and transmits in the third data signal 204C) a third synchronization code that includes the Task ID for Task-0 and the Controller ID for the third controller 112C.

The fourth controller 112D operates in the same manner as described above for the third controller 112C, and transmits the fourth data signal 204D to the first controller 112A. Responsive to receiving the fourth data signal 204D, the first controller 112A updates its interrupt status register 520 to reflect receipt of the Task ID for Task-0 from the other controllers 112B-D (as they arrive) as well as receipt of the Task ID for Task-0 from its own first synchronization code that has been relayed through the ring architecture. Once the first controller 112A has received the Task ID for Task-0 from all three other controllers 112B-D and received its own relayed copy, the interrupt enable signal for Task-0 can be produced (and/or the interrupt enable bit for Task-0 set) at the first controller, triggering the first controller to execute Task-0. A similar process can be performed at/by each of the other controllers 112B-112D. In this manner, execution of any given task can be synchronized among all the controllers (e.g., all four controllers 112A-D) in the group.

The controllers 112A-D may perform multiple tasks over the same time period. Accordingly, the data signals 204 transmitted among the controllers 112 at any time may include synchronization codes 302 associated with one or more tasks. At each controller, the interrupt status register 520 can be used to simultaneously monitor receipt of Task IDs for multiple tasks. Thus, any controller 112 does not need to receive the Task ID for Task-0 from all controllers before moving on to monitoring for Task IDs for another task (e.g., Task-1). Rather, the controllers 112 may monitor and count Task IDs for any number of tasks (e.g., Task-0, Task-1 . . . Task-n) at the same time, and the processing circuitry 510 generates an interrupt enable signal for a particular task as the threshold (e.g., the Task ID is received from all controllers) is reached for that particular task (thereby triggering the controller to execute that task), while continuing to monitor for other Task IDs.

Continuing with the example of FIG. 5, the interrupt status register 520 may thus include a set of bits for each individual Task ID that has been programmed for the system. In some instances, depending on the number of unique Task IDs and number of bits available in any one register, the interrupt status register 520 may include one or more registers that are collectively considered as the interrupt status register 520.

As described above, as synchronization codes 302 that have been extracted from the incoming data signal 204 by the input data router 514 and stored in the synchronization buffer 518 are processed by the processing circuitry 510, the interrupt status register 520 can be appropriately updated. In this manner, the processing circuitry 510 keeps and updates a record of the Task IDs received from other controllers (e.g., referred to as an interrupt status record). In some examples, when the record reaches a threshold, the interrupt signal 536 can be generated, triggering the controller 112 to perform the corresponding task. In some examples, the record reaches the threshold when the counter represented in the interrupt status register 520 reaches a value that corresponds to the number of controllers in the group (e.g., 4 in the example of FIG. 2). In other examples, the record reaches the threshold when all the counting bits for a particular Task ID are set (thus indicating that the Task ID has been received from all controllers in the group). In some examples, interrupt enable signals 534 for individual Task IDs are input to the interrupt circuitry 524 which outputs the interrupt signal 536 to trigger the processor 208 to cause, or instruct, the controller firmware to execute the corresponding task.

In some examples, the interrupt signal 536 may be produced responsive to the interrupt circuitry receiving an interrupt enable signal 534, as described above. However, in some examples, the interrupt circuitry 524 may produce the interrupt signal 536 responsive to another condition, such as occurrence of an error. In such examples, the interrupt signal 536 may trigger the processor 208 to perform another action, such as initiating a debug sequence or indicating an error, for example.

Error conditions may arise responsive to various events. In some examples, an error condition may occur when the MCS circuit 206 receives a synchronization code in error. Accordingly, the processing circuitry 510 may include synchronization interface circuitry, represented schematically in FIG. 5 as decision block 542, that may determine whether or not a synchronization code has been received in error or is associated with an error. The synchronization interface circuitry 542 may include logic circuitry for reading the Task IDs and Controller IDs contained in the synchronization codes 302. In some examples, the synchronization interface circuitry 542 may include (or may be coupled to) the synchronization buffer 518 and/or the receive buffer 522. In some examples, an error condition may occur when the MCS circuit 206 receives the same synchronization code (e.g., including the same Task ID and Controller ID) more than once before the counting bits (or counter) of the interrupt status register 520 for that Task ID have been reset. This error may arise because a controller 112 in the group has been erroneously configured with the same Controller ID as another controller 112 in the group. Bit errors in transmission of the data signals 205 may also produce this error in some instances. In some examples, when this error occurs, the processing circuitry 510 may load the synchronization code 302 that caused the error into the receive buffer 522 (accordingly, the receive buffer 522 may be referred to an error buffer). In some examples, responsive to a synchronization code being written to the receive buffer 522, a signal 538 indicating that the receive buffer 522 contains data (e.g., is not empty) may be provided to the interrupt circuitry 524, causing the interrupt signal 536 to be provided to the processor 208. In such instances, responsive to receiving the interrupt signal 536, the processor 208 may read the receive buffer 522 to retrieve the synchronization code for debug purposes, for example.

In some examples, the interrupt circuitry 524 may produce the interrupt signal 536 responsive to an error signal 540 from one or other components of the MCS circuit 206. For example, any of the buffers (e.g., the first transmit buffer 526, the second transmit buffer 528, or the receive buffer 522) may provide an error signal 540 indicating errors such as a buffer underflow or overflow event, for example. In this manner, the processor 208 may be alerted to errors within the MCS circuit 206 such that the processor 208 may take remedial action or indicate an error to a user or external computing device, for example. In other examples, any number of other error conditions may be reported via the interrupt circuitry 524.

In some examples, the interrupt circuitry 524 generates the interrupt signal 536 that is provided to the processor 208. In some examples, the interrupt circuitry 524 may include an interrupt register that can collect data representing errors in the MCS circuit 206. This interrupt register can be polled by software executing on the processor 208 or may be used to trigger output of the interrupt signal 536.

### Example Methodology

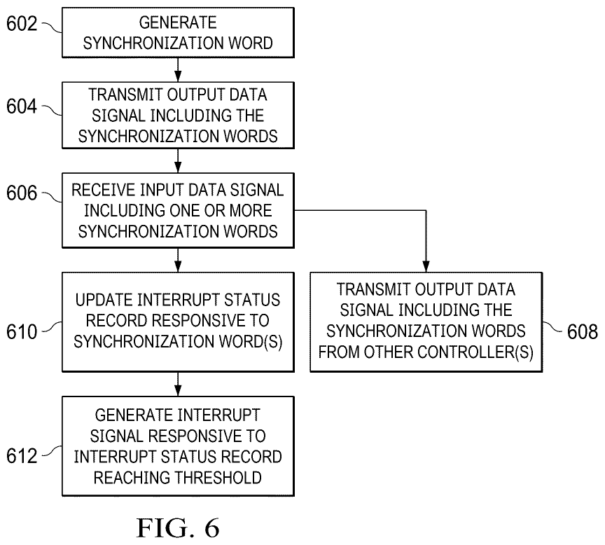

FIG. 6 is a flow diagram of a method of multi-controller synchronization according to an example. In some instances, the method may be implemented by a controller 112, using the MCS circuit 206 described above.

At operation 602, a synchronization word (e.g., a synchronization word 302) is generated by a controller 112. In some examples, the synchronization word can be generated by the processor 208 and stored in the first transmit buffer 526, as described above. The synchronization word may include a Task ID that identifies a particular task to be executed by the controllers 112 in a coordinated group of controllers. The synchronization word may also include a Controller ID that identifies the controller 112 that generated the synchronization word.

At operation 604, the controller 112 that generated the synchronization word at operation 602 transmits an output data signal (e.g., DATA_OUT), including the synchronization word generated at operation 602. As described above, the controller 112 may be coupled to one or more other controllers 112 in a ring configuration, and may transmit the synchronization word(s) it generates to the next controller in the ring.

At operation 606, an input data signal (e.g., DATA_IN) is received at the controller 112. The input data signal may include one or more other synchronization words originating from other controllers. In some instances, the input data signal may include the synchronization word generated by the controller 112 at operation 602, which has travelled around the ring configuration to thus be returned to the originating controller 112. As described above, in some examples, the input data signal 204 can be received and deserialized for processing by the input circuitry 506 of the MCS circuit 206. As part of this processing, the controller 112 may separate its own received synchronization word out from other synchronization words originating from other controllers 112 and that are to be relayed to the next controller in the ring, as described above.

Accordingly, at operation 608, an output data signal (e.g., DATA_OUT) is produced and transmitted by the controller 112. As described above, the output data signal 204 may include the other synchronization words from other controllers received at operation 606. For example, as described above, individual controllers 112 in the group can be coupled together in a ring configuration, such that each controller may relay synchronization words received from a preceding controller in the ring to the next controller in the ring, while also transmitting the synchronization word(s) it generates to the next controller in the ring at operation 604. In this manner, synchronization words originating at each controller in the ring configuration can be passed from one controller to the next via the data signals 204.

At operation 610, an interrupt status record can be undated responsive to the one or more synchronization words received at operation 606. As described above, in some examples, the MCS circuit 206 includes an interrupt status register 520 that can record receipt of Task IDs from individual controllers 112 in the group. Sets of one or more bits of the interrupt status register 520 may represent the interrupt status record, as described above. As a controller 112 receives synchronization words at operation 606, it may update the interrupt status register 520 to reflect which synchronization words have been received from which controllers, including itself.

At operation 612, an interrupt signal is generated responsive to the interrupt status record reaching a threshold. As described above, in some examples, a controller 112 may wait to execute a particular task until it receives the Task ID for that particular task from all controllers (including the Task ID included in its own synchronization word generated at operation 602) in the ring configuration. Accordingly, the threshold may represent receipt of the Task ID from all controllers. As described above, in some examples, the MCS circuit 206 may operate in an interrupt-driven mode of operation in which the interrupt signal 536 can be generated by the processing circuitry 510 and provided (e.g., via the interrupt circuitry 524) to the processor 208. In other examples, the MCS circuit 206 may operate in a software-polling mode of operation in which the processor 208 may periodically poll the interrupt circuitry 524 (e.g., read an interrupt register included in the interrupt circuitry 524 as described above) to read the interrupt signal 536 as the status of one or more bits of the interrupt register. As described above, in some examples, receipt (or reading) of the interrupt signal 536 by the processor 208 may trigger the processor 208 to cause or instruct the controller firmware to execute the task corresponding to the Task ID.

### CONCLUSION

Thus, aspects and examples provide a mechanism by which multiple controllers in a coordinating group can share task information reliably and real-time with very low latency. The task information can be used to synchronize execution of time-sensitive (and/or other) tasks among the multiple controllers during run-time, with the controller firmware optionally executing multiple tasks at any time. As described above, the task information (e.g., Task ID and Controller ID) can be structured as a one-byte (or other sized) synchronization word that can be relayed (or otherwise shared) among the multiple controllers in real time and at very high speed (e.g., up to 75-100 MHz, for example). Using these synchronization words for synchronization among the controllers allows time-sensitive (and/or other) tasks to be synchronized during firmware execution without relying on a synchronous shared clock or shared memory access among the controllers. Furthermore, task information sharing between controllers may be faster and use less data overhead than standard communication peripheral protocols such as I2C, SPI, UART, CAN, etc. In addition, the ring architecture described above removes the need for data arbitration since the controllers are not required to share a single communication bus.

The above descriptions relating to light projection systems, imaging systems, and/or image display systems provide only some examples of environments or applications within which techniques and structures described herein may be implemented.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/−10 percent of that parameter or +/−5 percent of that parameter.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Further Examples

The following examples pertain to further arrangements and/or implementations, from which numerous permutations and configurations will be apparent.

Example 1 is a method comprising: generating, at a first controller, a first synchronization word for a task, the first synchronization word including a first controller identification (ID) that identifies the first controller; outputting, by the first controller, an output data signal including the first synchronization word; receiving, at the first controller, an input data signal that includes a second synchronization word for the task, the second synchronization word including a second controller ID that identifies a second controller; updating, with synchronization circuitry of the first controller and responsive to receiving the second synchronization word, an interrupt status record for the task; generating, with the synchronization circuitry and responsive to the interrupt status record reaching a threshold, an interrupt signal instructing the first controller to perform the task; and outputting, by the first controller, the output data signal including the second synchronization word.

Example 2 includes the method of Example 1, wherein the first and second controllers are members of a group of N controllers, N being an integer number greater than one; wherein updating the interrupt status record includes incrementing the interrupt status record responsive to receiving synchronization words for the task, the synchronization words including the first and second synchronization words; and wherein the threshold value is N.

Example 3 includes the method of Example 2, wherein the N controllers are connected to one another in a ring configuration, and wherein the input data signal further includes the first synchronization word; and wherein updating the interrupt status record includes updating, with the synchronization circuitry of the first controller and responsive to receiving the first synchronization word, the interrupt status record for the task.

Example 4 includes the method of one of Examples 2 or 3, wherein the input data signal further includes one or more additional synchronization words for the task, each additional synchronization word including a respective additional controller ID identifying a respective additional controller of the N controllers.

Example 5 includes the method of any one of Examples 1-4, wherein the outputting the output data signal comprises: storing the first synchronization word in a first transmit buffer; storing the second synchronization word in a second transmit buffer; and serializing the first and second synchronization words to form the output data signal.

Example 6 includes the method of any one of Examples 1-5, wherein the input data signal further includes one or more additional synchronization words for another task, the method further comprising updating, with the synchronization circuitry of the first controller and responsive to receiving the one or more additional synchronization words, another interrupt status record for the another task.

Example 7 is a device configurable to implement the method of any one of Examples 1-6.

Example 8 includes the device of Example 7, wherein the device is a controller in a digital light projection system.

Example 9 is a controller comprising: a processor configured to generate a first synchronization word including a task identification (ID) and a first controller ID; and synchronization circuitry coupled to the processor. The synchronization circuitry includes: input circuitry having a data input port to receive an input data signal, and a clock input port to receive an input clock signal, the input data signal including a second synchronization word that includes the task ID and a second controller ID; synchronization interface circuitry coupled to the processor and to the input circuitry, the synchronization interface circuitry configured to store the first and second synchronization words and an interrupt status record for the task ID; and output circuitry coupled to the input circuitry and to the processor, the output circuitry having a data output port and a clock output port, the output circuitry configured to provide, at the data output port, an output data signal including the first synchronization word and the second synchronization word, and to provide, at the clock output port, an output clock signal; wherein the synchronization circuitry is configured to update the interrupt status record for the task ID responsive to receiving the second synchronization word, and to generate an interrupt to the processor responsive to the interrupt status record reaching a threshold value, the threshold value being based on an expected number of controller IDs.

Example 10 includes the controller of Example 9, wherein the synchronization interface circuitry comprises: a synchronization buffer coupled to the input circuitry and configured to store the second synchronization word; and one or more synchronization registers configured to store the interrupt status record.

Example 11 includes the controller of Example 10, wherein the one or more synchronization registers includes a register that stores the first synchronization word.

Example 12 includes the controller of one of Examples 10 or 11, wherein the controller is a member of a group of N controllers coupled together in a ring configuration, N being an integer number greater than one; wherein the input data signal further includes the first synchronization word; wherein the synchronization circuitry is configured to increment the interrupt status record responsive to receiving synchronization words having the task ID, the synchronization words including the first and second synchronization words; and wherein the threshold value is N.

Example 13 includes the controller of Example 12, wherein the input data signal further includes one or more additional synchronization words having the task ID, each additional synchronization word including a respective additional controller ID identifying a respective additional controller of the N controllers.

Example 14 includes the controller of Example 13, wherein: the synchronization interface circuitry further comprises an error buffer coupled to the synchronization buffer and to the processor; the synchronization interface circuitry is configured to determine whether the one or more additional synchronization words has been received in error; and the synchronization interface circuitry is configured to (i) update the interrupt status record, responsive to determining that the one or more additional synchronization words have not been received in error, to count the one or more additional synchronization words, or (ii) route the one or more additional synchronization words to the error buffer responsive to determining that that the one or more additional synchronization words have been received in error.

Example 15 includes the controller of any one of Examples 10-14, wherein the task ID is a first task ID; the input data signal further includes one or more additional synchronization words having a second task ID; the interrupt status record is a first interrupt status record; and the synchronization circuitry is configured to update a second interrupt status record for the second task ID responsive to receiving the one or more additional synchronization words.

Example 16 includes the controller of any one of Examples 9-15, wherein the output circuitry comprises: a first transmit buffer coupled to the processor and configured to store the first synchronization word; a second transmit buffer coupled to the input circuitry and configured to store the second synchronization word; and an output data router configured to serialize the first and second synchronization words to form the output data signal.

Example 17 includes the controller of Example 16, wherein the output circuitry further comprises an output shift register coupled to the clock output port and coupled between the output data router and the data output port, the output shift register configured to provide the output data signal to the data output port and to provide the output clock signal to the clock output port.

Example 18 is a system comprising: a plurality of controllers each having a data input terminal, a data output terminal, a clock input terminal, and a clock output terminal, the plurality of controllers connected to one another in a ring configuration. Each controller comprises: a processor configured to generate a synchronization word that identifies the controller and a task; and synchronization circuitry coupled to the data input terminal, the data output terminal, the clock input terminal, the clock output terminal, and the processor. The synchronization circuitry is configured to: update an interrupt status record for the task responsive to receiving, via the data input terminal, an input data signal including one or more synchronization words from at least one of the plurality of controllers, the one or more synchronization words identifying the task; generate an interrupt to the processor responsive to the interrupt status record for the task reaching a threshold value, the interrupt instructing the processor to perform the task, and the threshold value corresponding to a number of controllers in the plurality of controllers; and provide, at the data output terminal, an output data signal that includes the synchronization word generated by the processor and the one or more synchronization words received included in the input data signal.

Example 19 includes the system of Example 18, wherein the clock input terminal of each respective controller is coupled to the clock output terminal of a respective other controller, and wherein the data input terminal of each respective controller coupled to the data output terminal of the respective other controller.

Example 20 includes the system of one of Examples 18 or 19, wherein each controller is further configured to: receive an input clock signal via the clock input terminal; and provide an output clock signal via the clock output terminal; wherein the input clock signal and the output clock signal have a same clock frequency.

Example 21 includes the system of any one of Examples 18-20, wherein the synchronization circuitry further comprises an error buffer coupled to the processor; wherein the synchronization circuitry is configured to determine whether a first synchronization word of the one or more synchronization words has been received in error; and wherein the synchronization circuitry is configured to (i) update the interrupt status record to count the first synchronization word responsive to determining that the first synchronization word has not been received in error, or (ii) route the first synchronization word to the error buffer responsive to determining that that the first synchronization word has been received in error.

Example 22 includes the system of any one of Examples 18-21, wherein the system is a light projection system further comprising a display device and a light source; and wherein the plurality of controllers are display controllers coupled to the display device and configured to control the display device to display an image responsive to the display device being illuminated by light from the light source.

Example 23 includes the system of Example 22, wherein the display device includes a spatial light modulator.

Example 24 includes the system of one of Examples 22 or 23, wherein the plurality of controllers are further coupled to the light source and configured to control the light source to illuminate the display device.

1. A method comprising:
generating, at a first controller, a first synchronization word for a task, the first synchronization word including a first controller identification (ID) that identifies the first controller;
outputting, by the first controller, an output data signal including the first synchronization word;
receiving, at the first controller, an input data signal that includes a second synchronization word for the task, the second synchronization word including a second controller ID that identifies a second controller;
updating, with synchronization circuitry of the first controller and responsive to receiving the second synchronization word, an interrupt status record for the task;
generating, with the synchronization circuitry and responsive to the interrupt status record reaching a threshold value, an interrupt signal instructing the first controller to perform the task; and
outputting, by the first controller, the output data signal including the second synchronization word.

2. The method of claim 1, wherein the first and second controllers are members of a group of N controllers, N being an integer number greater than one;
wherein updating the interrupt status record includes incrementing the interrupt status record responsive to receiving synchronization words for the task, the synchronization words including the first and second synchronization words; and
wherein the threshold value is N.

3. The method of claim 2, wherein the N controllers are connected to one another in a ring configuration, the method further comprising
receiving, at the first controller, the input data signal including the first synchronization word; and
wherein updating the interrupt status record includes updating, with the synchronization circuitry of the first controller and responsive to receiving the first synchronization word, the interrupt status record for the task.

4. The method of claim 2, wherein the input data signal further includes one or more additional synchronization words for the task, each additional synchronization word including a respective additional controller ID identifying a respective additional controller of the N controllers.

5. The method of claim 1, wherein the outputting the output data signal comprises:
storing the first synchronization word in a first transmit buffer;
storing the second synchronization word in a second transmit buffer; and
serializing the first and second synchronization words to form the output data signal.

6. The method of claim 1, wherein the input data signal further includes one or more additional synchronization words for another task, the method further comprising:
updating, with the synchronization circuitry of the first controller and responsive to receiving the one or more additional synchronization words, another interrupt status record for the another task.

7. A controller comprising:
a processor configured to generate a first synchronization word including a task identification (ID) and a first controller ID; and
synchronization circuitry coupled to the processor, the synchronization circuitry including
input circuitry having a data input port to receive an input data signal, and a clock input port to receive an input clock signal, the input data signal including a second synchronization word that includes the task ID and a second controller ID,
synchronization interface circuitry coupled to the processor and to the input circuitry, the synchronization interface circuitry configured to store the first and second synchronization words and an interrupt status record for the task ID, and
output circuitry coupled to the input circuitry and to the processor, the output circuitry having a data output port and a clock output port, the output circuitry configured to provide, at the data output port, an output data signal including the first synchronization word and the second synchronization word, and to provide, at the clock output port, an output clock signal;
wherein the synchronization circuitry is configured to update the interrupt status record for the task ID responsive to receiving the second synchronization word, and to generate an interrupt to the processor responsive to the interrupt status record reaching a threshold value, the threshold value being based on an expected number of controller IDs.

8. The controller of claim 7, wherein the synchronization interface circuitry comprises:
a synchronization buffer coupled to the input circuitry and configured to store the second synchronization word; and
one or more synchronization registers configured to store the interrupt status record.

9. The controller of claim 8, wherein the one or more synchronization registers includes a register that stores the first synchronization word.

10. The controller of claim 8, wherein the controller is a member of a group of N controllers coupled together in a ring configuration, N being an integer number greater than one;
wherein the input data signal further includes the first synchronization word;
wherein the synchronization circuitry is configured to increment the interrupt status record responsive to receiving synchronization words having the task ID, the synchronization words including the first and second synchronization words; and
wherein the threshold value is N.

11. The controller of claim 10, wherein the input data signal further includes one or more additional synchronization words having the task ID, each additional synchronization word including a respective additional controller ID identifying a respective additional controller of the N controllers.

12. The controller of claim 11, wherein:
the synchronization interface circuitry further comprises an error buffer coupled to the synchronization buffer and to the processor;
the synchronization interface circuitry is configured to determine whether the one or more additional synchronization words has been received in error; and
the synchronization interface circuitry is configured to (i) update the interrupt status record, responsive to determining that the one or more additional synchronization words have not been received in error, to count the one or more additional synchronization words, or (ii) route the one or more additional synchronization words to the error buffer responsive to determining that that the one or more additional synchronization words have been received in error.

13. The controller of claim 8, wherein:
the task ID is a first task ID;
the input data signal further includes one or more additional synchronization words having a second task ID;
the interrupt status record is a first interrupt status record; and
the synchronization circuitry is configured to update a second interrupt status record for the second task ID responsive to receiving the one or more additional synchronization words.

14. The controller of claim 7, wherein the output circuitry comprises:
a first transmit buffer coupled to the processor and configured to store the first synchronization word;
a second transmit buffer coupled to the input circuitry and configured to store the second synchronization word; and
an output data router configured to serialize the first and second synchronization words to form the output data signal.

15. The controller of claim 14, wherein the output circuitry further comprises an output shift register coupled to the clock output port and coupled between the output data router and the data output port, the output shift register configured to provide the output data signal to the data output port and to provide the output clock signal to the clock output port.

16. A system comprising:
a plurality of controllers each having a data input terminal, a data output terminal, a clock input terminal, and a clock output terminal, the plurality of controllers connected to one another in a ring configuration;
wherein each controller comprises
a processor configured to generate a synchronization word that identifies the controller and a task, and
synchronization circuitry coupled to the data input terminal, the data output terminal, the clock input terminal, the clock output terminal, and the processor; and wherein the synchronization circuitry is configured to
update an interrupt status record for the task responsive to receiving, via the data input terminal, an input data signal including one or more synchronization words from at least one of the plurality of controllers, the one or more synchronization words identifying the task,
generate an interrupt to the processor responsive to the interrupt status record for the task reaching a threshold value, the interrupt instructing the processor to perform the task, and the threshold value corresponding to a number of controllers in the plurality of controllers, and
provide, at the data output terminal, an output data signal that includes the synchronization word generated by the processor and the one or more synchronization words received included in the input data signal.

17. The system of claim 16, wherein each controller is further configured to:
receive an input clock signal via the clock input terminal; and
provide an output clock signal via the clock output terminal;
wherein the input clock signal and the output clock signal have a same clock frequency.

18. The system of claim 16, wherein the synchronization circuitry further comprises an error buffer coupled to the processor;
wherein the synchronization circuitry is configured to determine whether a first synchronization word of the one or more synchronization words has been received in error; and
wherein the synchronization circuitry is configured to (i) update the interrupt status record to count the first synchronization word responsive to determining that the first synchronization word has not been received in error, or (ii) route the first synchronization word to the error buffer responsive to determining that that the first synchronization word has been received in error.

19. The system of claim 16, wherein the system is a light projection system further comprising a display device and a light source; and
wherein the plurality of controllers are display controllers coupled to the display device and configured to control the display device to display an image responsive to the display device being illuminated by light from the light source.

20. The system of claim 19, wherein the plurality of controllers are further coupled to the light source and configured to control the light source to illuminate the display device.
